(19) United States
(12) Patent Application Publication
(10) Pub. No.: US 2020/0108916 A1
(43) Pub. Date: Apr. 9, 2020

(54) SKIN GROOVES USED FOR DIRECTING FLUID ON AIRCRAFT, LANDCRAFT, SPACECRAFT, AND WATERCRAFT RELATED VEHICLES OR PROPELLED/PROJECTILE OBJECTS

(71) Applicant: Taylor DiAnte' Brown, Jackson, MS (US)

(72) Inventor: Taylor DiAnte' Brown, Jackson, MS (US)

(21) Appl. No.: 16/226,528

(22) Filed: Dec. 19, 2018

Related U.S. Application Data
(60) Provisional application No. 62/740,884, filed on Oct. 3, 2018.

(51) Int. Cl. B64C 21/10; B62D 35/00

(52) U.S. Cl. CPC B64C 21/10; F15D 1/12; B62D 35/00

(57) ABSTRACT

The skin grooves provide a methodology in directing the flow of fluid on multiple types of vehicles and objects. The grooves within the skin allow the fluid to be directed. The grooves work similarly to a water slide. The groove within the water slide directs the water accordingly. By utilizing the same method of directing the flow of fluid on an aircraft, landcraft, spacecraft, and watercraft related vehicles or propelled/projectile objects, it provides limitations to drag.

### BACKGROUND OF THE INVENTION

Multiple companies, whether aerospace, automotive, or others, are looking for the best way to maximize performance in their vehicles. There has been extensive research in determining how to do this by reducing drag operating on a vehicle. Drag can be universally defined as fluid resistance. A fluid is categorized as gases, liquids, and plasmas. Fluid resistance relates to these substances opposing the motion of a vehicle. In order to reduce drag, engineers and scientists have tried their best to develop better streamlined body vehicles to help in this area. By altering the shape of a vehicle, drag can be reduced. To further discover the best streamlined body vehicle, the skin or surface shape of a vehicle was taken into consideration.

This invention is to be applied in the field of fluid mechanics. The skin grooves are designed to guide the flow of fluid that touch the vehicles and objects. Skin is defined as the outer layer of a vehicle or object. Grooves are defined as, but not limited to, any depression in the surface, and these grooves guide the motion of fluid particles. The current design of the skin or surface on vehicles and objects allows fluid to freely roam. The ability to direct fluid decreases drag of the vehicle or object of interest.

### BRIEF SUMMARY OF THE INVENTION

The skin grooves allow the separation and guiding of fluid particles. The fluid particles are guided to maintain the desired course of travel. The guiding of fluid particles can help predict motion and minimize drag.

### BRIEF DESCRIPTION OF THE DRAWINGS

FIG. 1A—FIG. 1A displays the front view of the aircraft. FIG. 1A has the number 1 pointing to the depression in the skin of the aircraft to illustrate an example of the curvature in the skin groove. The number 2 placed on the bottom right surface of the aircraft is showing an example of a skin groove section for the front of the aircraft. FIG. 1A displays 6 skin groove sections that join together at a point.

FIG. 1B—FIG. 1B displays the side view of the aircraft. FIG. 1B displays two skin groove sections joined together at the middle of the fuselage which start from the nose and continue throughout the side of the aircraft. The number 3 is on the surface of a skin groove section. The number 3 in FIG. 1B and the number 2 in FIG. 1A denote the same skin groove section. The skin groove section denoted as number 3 in FIG. 1B is the side view and continuation of the skin groove section denoted as number 2 in FIG. 1A. The curve line with two oblique lines intersecting its middle on the far right of the figure denotes the end point of interest of the aircraft.

FIG. 1C—FIG. 1C displays the top view of the aircraft. FIG. 1C displays three skin groove sections joined together on the fuselage respectively. The skin groove sections start at the tip of the nose of the aircraft and continue throughout the top of the aircraft. The curve line with two oblique lines intersecting its middle on the bottom of the figure denotes the end point of interest of the aircraft.

### DETAILED DESCRIPTION OF THE INVENTION

The terminology within this section is used for describing the characteristics, functionality, and uses thereof. The term “and/or” used within a sentence denotes any and all combinations of one or more of the associated listed elements. The singular forms of “a,” “an,” and “the” are also intended to include the plural forms unless otherwise stated. It is presumed that scientific, technical, engineering, and mathematical terms are universally defined. It is further understood that these definitions are not limited to their common definitions and may be found through the use of dictionaries or other sources.

In travel, the object of interest encounters fluid along its surface or skin. Fluid is defined as, but not limited to, any gas, liquid, or plasma. When the fluid contacts the surface of the object, the fluid adjusts its traveling path with respect to the shape of the object. Once the traveling path is adjusted through the initial contact, there has not been a direct way on how to control the path of the fluid from being deterred off course. The fluid particles were able to freely roam after initial contact.

The skin grooves are designed to guide the flow and travel of fluid particles. By guiding fluid particles, it provides a predictable flow of fluid. The grooves guide the fluid to travel along a designated pathway to limit collision with other fluid particles. The limitation of collision with other fluid particles limits drag. Drag is the opposing force operating on the surface of an object while it is in travel.

There are multiple types of vehicles and objects that have skin or surface areas that can utilize this invention such as: an aircraft, spacecraft, watercraft landcraft, propelled object, and projectile object. The following definitions of an aircraft, spacecraft, watercraft, landcraft, propelled object, and projectile object are simply defined, and are not limited to these definitions. An aircraft is any vehicle made to fly within the Earth's atmosphere. A spacecraft is any vehicle made to exit the Earth's atmosphere. A watercraft is any vehicle made to travel through or under water. A landcraft is any vehicle made to travel along the land. A propelled object is any object that has a propulsion system to propel the object in a designated direction. A projectile object is any object that has the capability of being launched from a person's hand or a platform.

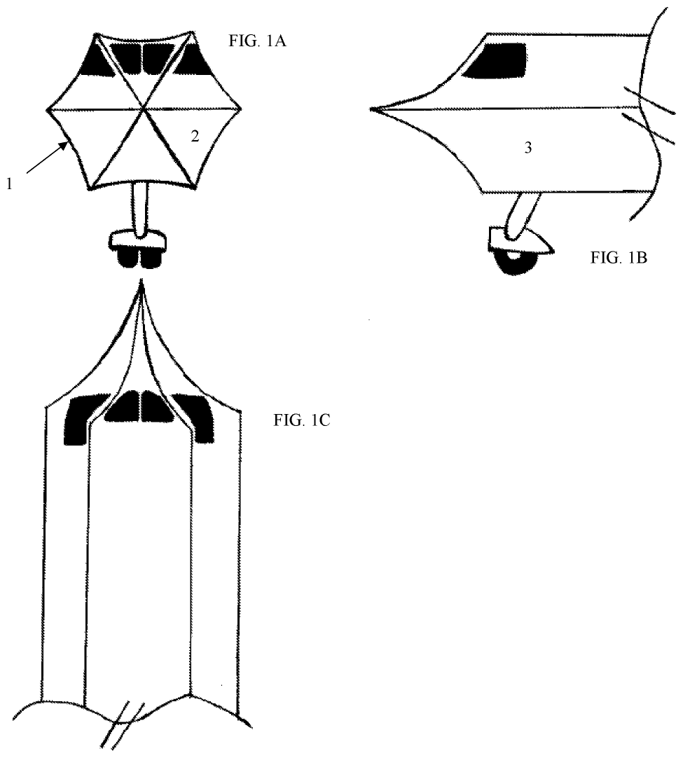

FIGS. 1A, 1B, and 1C show examples of the skin grooves being used on an aircraft. It is presumed that these figures do not limit the scope or usefulness of the invention. FIG. 1A shows the front of an aircraft. The number 1 pointing to the curvature in the picture highlights the depression within the skin to illustrate a groove in the aircraft. The number 2 attached to the surface of the aircraft highlights one out of six groove sections on the aircraft. The fluid is designated to travel within the region of these groove sections starting from the front of the aircraft throughout the top, sides, and bottom of the aircraft. The number 3 in FIG. 1B shows the continuation of the skin groove section denoted as number 2 in FIG. 1A. When the fluid encounters the front groove section where the number 2 is located, it will continue along the groove section of the aircraft where the number 3 is located.

An example to understand this functionality is to observe a water slide. The groove within a water slide guides the water in a uniform fashion. The fluid in this example is air when observing an aircraft. The air is guided in the same way the water is guided in a water slide. Once the air contacts the front of the aircraft, the air continues throughout the rest of the aircraft within the bounds of the grooves. For observation, FIG. 1B and FIG. 1C allows the viewer to see the continuation of grooves throughout the side and top of the aircraft starting from the nose of the aircraft.

It is presumed that the processes, manufacturability, and assembly of the skin grooves should follow the same guidelines in how regular skin surfaces for vehicles and objects are made. The word “regular” means not made with grooves that guide fluid.

The claimed invention is:

1. Aircraft, landcraft, spacecraft, and watercraft related vehicle(s) or propelled/projectile object(s) comprising of skin grooves that direct fluid, as defined in the detailed description.
